(19) United States
(12) Patent Application Publication
(10) Pub. No.: US 2015/0313259 A1
(43) Pub. Date: Nov. 5, 2015

(54) FEED ADDITIVE AND MIXED FEED

(71) Applicant: KURITA WATER INDUSTRIES LTD., Nakano-ku, Tokyo (JP)

(72) Inventors: Hiromi AZUMA, Nakano-ku, Tokyo (JP); Tetsurou FUKASE, Nakano-ku, Tokyo (JP)

(21) Appl. No.: 14/650,755

(22) PCT Filed: Dec. 10, 2013
(86) PCT No.: PCT/JP2013/083052

§ 371 Date: Jun. 9, 2015

(30) Foreign Application Priority Data
Dec. 12, 2012 (JP) 2012-271516

(51) Int. Cl. A23K 1/10; A23K 1/18

(52) U.S. Cl. CPC A23K 1/10; A23K 1/188

(57) ABSTRACT

Provided are an inexpensive feed additive including a metazoan animal as a feeding stimulant, and a mixed feed including the additive. The feed additive contains a metazoan animal or an aerobically biotreated sludge containing a metazoan animal. The content of the metazoan animal in the feed additive is 1 wt % or more on dry basis, and the content of a free amino acid in the feed additive is 0.5 wt % or more on dry basis. The metazoan animal is preferably based on rotifers. The mixed feed includes the feed additive and a feedstuff with the content of the feed additive of 0.1 to 30 wt % on dry basis.

### FIELD OF INVENTION

The present invention relates to an inexpensive feed additive including metazoan animals as feeding stimulants, and to a mixed feed including the feed additive.

### BACKGROUND OF INVENTION

With the exhaustion of natural resources worldwide, animal proteins such as fishmeal that are used as feed materials for cultivation are becoming scarce and expensive. While use is being made of plant alternative proteins, they have problems such as poor feeding efficiency due to low digestibility and preference. Thus, there have been demands for inexpensive animal proteins.

Rotifers are widely used as an animal feedstuff for the production of, for example, seed sludge for marine fish (Patent Literature 1). Patent Literature 1 describes a fish culturing feed obtained by adding a free branched-chain amino acid to a feedstuff such as rotifers. With this fish culturing feed containing a free branched-chain amino acid, fish may be cultured at an increased growth rate.

Patent Literature 2 describes a feed for Thunnus fish obtained by adding an amino acid and inosinic acid as feeding stimulants to an oxygen-treated fishmeal.

The feeds described in Patent Literatures 1 and 2 are very expensive because the amino acids added to the feedstuffs such as rotifers and fishmeal are synthetic amino acids.

### LIST OF LITERATURE

Patent Literature 1: Japanese Patent Publication 2010-187612 A

Patent Literature 2: Japanese Patent Publication 2006-223164 A

### SUMMARY OF INVENTION

An object of the invention is to provide an inexpensive feed additive including a microscopic animal such as a metazoan animal as a feeding stimulant, and to provide a mixed feed including the additive.

A feed additive of the present invention includes a metazoan animal or an aerobically biotreated sludge containing a metazoan animal, the content of the metazoan animal in the feed additive being 1 wt % or more on dry basis, the content of a free amino acid in the feed additive being 0.5 wt % or more on dry basis.

The metazoan animal is preferably based on rotifers.

A mixed feed of the present invention includes the feed additive of the invention and a feedstuff, the content of the feed additive being 0.1 to 30 wt % on dry basis.

### Advantageous Effects of Invention

The feed additive of the present invention contains an amino acid-rich microscopic animal as a feeding stimulant and are inexpensive as compared to the feeds described in Patent Literatures 1 and 2 which use synthetic amino acids as feeding stimulants.

The properties such as color and hardness of the mixed feed containing the feed additive are the same as the conventional feeds, and thus the manner in which animals are fed is not affected. With use of this mixed feed, the rate of feed consumption by animals such as fish is enhanced and good feeding results are obtained.

According to the present invention, microscopic animals such as rotifers are cultured with byproducts such as cooking water made in food factories. Thus, the invention not only contributes to the conservation of resources and to the realization of a recycling society, but also can provide safe and inexpensive feed additives and mixed feeds.

### BRIEF DESCRIPTION OF DRAWING

FIG. 1 is a flow diagram illustrating an example of a process of producing a feed additive.

### DESCRIPTION OF EMBODIMENTS

A feed additive of the invention includes 1 wt % or more on dry basis, in particular, 1 to 80 wt %, preferably 5 to 80 wt %, and more preferably 10 to 70 wt % of metazoan animals, the balance being a sludge other than the metazoan animals. The sludge other than the metazoan animals is generated by the aerobic biological treatment of an organic wastewater in which the metazoan animals are cultured, and includes bacteria, protozoans, organic SS and inorganic SS (such as hard components and minerals). The phrase that the feed additive contains 1 wt % or more of metazoan animals on dry basis means that the content of the metazoan animals in the feed additive dried at 105° C. until a constant weight is reached is 1 wt % or more.

The metazoan animals are preferably based on rotifers. It is preferable that the metazoan animals include 10 wt % or more, and particularly 20 wt % or more of rotifers. Various kinds of rotifers may be used, with examples including Brachionus plicatilis rotifers, Euchlanis rotifers, Rotaria and Philodina rotifers, Polyarthra rotifers, Filinia rotifers, Hexarthra rotifers, Cephalodella rotifers, Trichocerca rotifers, Asplanchna rotifers, Brachionus rotifers, Keratella rotifers, Pompholyx rotifers, Testudinella rotifers, Synchaeta rotifers, Monommata rotifers, Ascomorpha rotifers and Ploesoma rotifers.

The metazoan animals may include animals other than the rotifers such as paramecium and aeolosoma.

In the invention, the feed additive preferably contains a free amino acid in an amount of not less than 0.5 wt %, particularly 0.5 to 5 wt %, and further particularly 2 to 5 wt % on dry basis. The microscopic animals containing such large amounts of free amino acids have an excellent feeding stimulant effect. The free amino acid is preferably at least one of arginine, lysine, leucine, isoleucine, valine, alanine, glycine, proline and glutamic acid. The above free amino acid content on dry basis is the free amino acid content determined by amino acid autoanalysis.

A mixed feed of the present invention includes the above feed additive and a feedstuff. In the mixed feed, the amount of the feed additive is preferably 0.1 to 30 wt %, and particularly 0.5 to 30 wt % on dry basis as measured with respect to the mixed feed dried at 105° C. until a constant weight is reached.

The feedstuff may be one, or two or more kinds of foods such as fishmeals, cereals, soybeans, gluten meals, wheat flours, fodder yeasts, oils and fats.

The mixed feed of the invention is produced by admixing the feed additive of the invention and optionally other additives (for example, vitamins, minerals, antibiotics and food additives) with the feedstuff. In the production, synthetic amino acids may be added as additives. In this case, the amount in which the synthetic amino acids are used may be reduced as compared to the conventional levels.

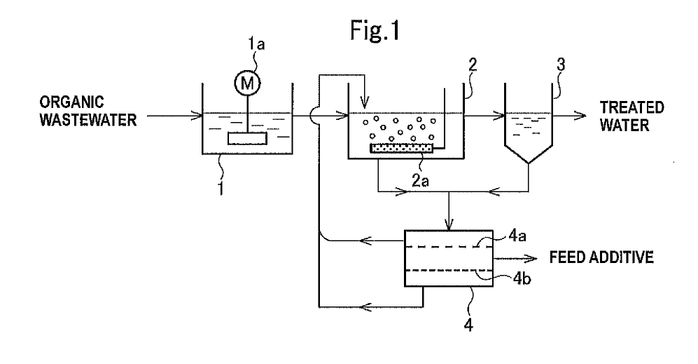

Next, a preferred process of producing the feed additive by the cultivation of microscopic animals will be described with reference to FIG. 1.

In this embodiment, as illustrated in FIG. 1, an organic wastewater containing protein in an amount of 40 wt % or more, for example, 40 to 60 wt %, is aerobically treated in a first aerobic reactor (biological treatment tank) 1 to culture bacteria, and the first treated water discharged from the first biological treatment tank 1 is introduced into a second aerobic reactor (biological treatment tank) 2 to allow microscopic animals (protozoans and metazoan animals) to prey on the bacteria present in the first treated water, thereby culturing the microscopic animals. In FIG. 1, the second treated water discharged from the second aerobic reactor 2 is introduced into a settling tank 3, and the solid and the liquid are separated and the treated water is discharged to the outside of the system.

Part of the sludge in the second aerobic reactor 2, and the sludge settled in the settling tank 3 are introduced into a thickener 4. The thickener 4 includes a first filter 4a having a larger mesh size and a second filter 4b having a smaller mesh size. The sludge having sizes which can pass through the first filter 4a but are retained on the second filter 4b is recovered as the feed additive or a raw material therefor.

When the organic wastewater contains 40 wt % or more protein, microscopic animals containing large amounts of free amino acids may be cultured.

Examples of the organic wastewaters containing 40 wt % or more protein include food factory wastewaters (for example, cooking water made in food factories), fishmeal dispersions, livestock wastewaters, blood wastewaters, cereal powder dispersions such as wastewater generated during rice washing, garbage dispersions, waste milk and waste beverages.

The organic wastewater preferably contains a glucide and/or a crude fat in an amount of 10 wt % or more, for example, 10 to 40 wt %, and particularly 20 to 40 wt %. The reason for this is because these components are necessary for the proliferation of microscopic animals.

The organic wastewater is continuously passed through the first aerobic reactor 1 preferably for a retention time of 2 to 12 hours, and thereby BOD components (organic components) are converted into microorganisms by bacteria (bacteria culture).

In the first aerobic reactor 1, bacteria which serve as food for microscopic animals such as rotifers are cultured. The bacteria as food for microscopic animals such as rotifers are preferably in the form of micro flocs having sizes of about 3 to 20 μm, and particularly 5 to 10 μm and contain large amounts of protein and glucide.

Such dispersed bacteria in the form of micro flocs may be obtained by continuous cultivation using a substrate, desirably a soluble polymer compound, that contains protein and glucide under aerobic conditions with a retention time of about 2 to 12 hours. The DO concentration in the first aerobic reactor 1 is preferably not less than 1 mg/L, particularly 1 to 10 mg/L, and further particularly 2 to 10 mg/L. Desirably, as illustrated in FIG. 1, a mixer 1a is fitted to the first aerobic reactor 1 to perform strong stirring.

Unlike the biological treatment of organic wastewater using microscopic animals (for example, Japanese Patent Publication 2006-247494 A), this method of culturing microscopic animals is aimed at stable mass cultivation of microscopic animals. Thus, the amount of BOD sludge in the first aerobic reactor is raised to as large as 2 kg/kg-MLSS/d or more, for example, 2 to 12 kg/kg-MLSS/d, and the DO (dissolved oxygen) concentration is elevated to as high as 1 mg/L or more, for example, 1 to 10 mg/L, and particularly 2 to 10 mg/L. Under these conditions, desirably, strong stirring is further performed at a shear force G of 5 to 100 s⁻¹ to distribute DO uniformly throughout the tank and thereby to suppress the dispersed bacteria from forming coarse flocs.

The pH in the first aerobic reactor 1 is preferably 5 to 9. In the case where the substrate includes oil, a slightly higher pH, specifically, a pH of about 8 to 9 is preferable.

As mentioned earlier, the retention time in the first aerobic reactor 1 is preferably 2 to 12 hours. When the organic matter in the wastewater is liquid such as soluble starch or fish extract, the retention time is preferably about 2 to 8 hours. When the organic matter is solid such as fishmeal or cereal powder, the retention time is preferably about 6 to 12 hours.

The temperature in the first aerobic reactor 1 is preferably 30 to 35° C. but may be in the range of 10 to 40° C.

By the cultivation of bacteria under the above conditions, nutritious dispersed bacteria suited as food for microscopic animals are produced continuously so as to achieve a weight corresponding to 40 to 70%, for example, about 50% of the organic matter in the organic wastewater added. When the protein content in the organic wastewater is high, the resultant bacteria contain large amounts of free amino acids, and the microscopic animals that have preyed on the bacteria become rich in free amino acids.

In the second aerobic reactor 2, microscopic animals are continuously cultured. It is preferable that a small amount of microscopic animals be added at the start of the cultivation optionally together with other components, for example, active sludge generated in facilities such as food factories, and the first treated water supplied from the first aerobic reactor 1 be added while aerating the system with an aeration unit such as an aeration tube 2a to maintain the DO concentration preferably at 1 mg/L or more, for example, 1 to 10 mg/L, and particularly 2 to 10 mg/L. The addition of the water is preferably continuous but may be batchwise in the initial stage. The pH in the second aerobic reactor 2 is desirably maintained at 7 to 8. The microscopic animals eat substantially the same weight of bacteria as their own weight per day when the temperature in the second aerobic reactor 2 is maintained at 25 to 30° C. Thus, the effluent from the first aerobic reactor is preferably added at a rate determined using this as a guideline.

After the continuation of the above operation, the concentration of the solid containing metazoan animals in the second aerobic reactor 2 is stabilized at about 3to 10 g/L on dry basis. The microscopic animals in the tank are based on rotifers that are metazoan animals, and include small amounts of other animals such as paramecium.

The second treated water discharged from the second aerobic reactor 2 is introduced into the settling tank 3. Solid liquid separation is performed, and the treated water is discharged to the outside of the system.

To recover the metazoan animals, the first filter 4a and the second filter 4b are installed with tension on an upper side and a lower side, respectively, in the thickener 4. The sludge settled in the second aerobic reactor 2, and the sludge settled in the settling tank 3 are guided to fall onto the first filter 4a. The sludge having sizes which are passed through the first filter 4a but are retained on the second filter 4b is collected from the thickener 4, thereby recovering a feed additive that is composed of the sludge containing metazoan animals. The feed additive is thereafter dehydrated as required to a water content of 90 wt % or less, for example, about 70 to 85 wt %. Where necessary, the feed additive may be dried for easy storage.

The mesh size of the first filter 4a is preferably 500 to 2000 μm, and particularly 1000 to 1500 μm, and the mesh size of the second filter 4b is preferably 20 to 50 μm, and particularly 20 to 30 μm. With these mesh sizes, the feed additive composed of the metazoan animal-containing sludge that is recovered from the thickener 4 has particle sizes of 20 to 2000 μm, and particularly 50 to 500 μm.

The oversize sludge retained on the first filter 4a, and the filtrate passed through the second filter 4b that contains such components as dispersed bacteria, protozoans and soluble organic components are preferably returned to the second aerobic reactor 2.

In the invention, only the sludge settled in the settling tank 3 may be introduced into the thickener 4.

The metazoan animals are desirably recovered partly rather than in the whole amount, namely, part of the metazoan animals are desirably left. The recovery may take place once per day to recover only an increase from the previous day. The increase (in weight) of the metazoan animals is 30 to 40% of the weight of the bacteria added. As mentioned earlier, approximately 50% of the saccharide and protein added are converted into bacteria in the first aerobic reactor 1. Thus, the metazoan animals that are cultured correspond to about 15 to 20 wt % of the saccharide and protein added to the first aerobic reactor 1.

As mentioned earlier, the metazoan animals recovered contain large amounts of free amino acids.

### EXAMPLES

### Example 1

A feed additive (a sludge containing metazoan animals) was recovered by culturing microscopic animals in accordance with the flow described in FIG. 1 under the following conditions. The mesh size of the first filter 4a was 1000 μm, and the mesh size of the second filter 4b was 20 μm. The whole amount of the sludge retained on the first filter 4a and the filtrate passed through the second filter 4b was returned to the second aerobic reactor 2.

Raw water: fish-processing wastewater containing 50 wt % protein, 30 wt % glucide and 10 wt % crude fat

First Aerobic Reactor
BOD sludge load: 5 kg/kg-MLSS/d
Shear force G: 5 s⁻¹
DO: 2 mg/L
pH: 7
temperature: 27° C.

Second Aerobic Reactor
SRT: 25 days
DO: 2 mg/L
pH: 7
temperature: 27° C.

Part of the metazoan animal-containing sludge that had been recovered was sampled, dehydrated with a centrifugal dehydrator to a water content of not more than 90 wt %, and dried at 105° C. until a constant weight was reached. The content of metazoan animals on dry basis was measured to be 10 wt %.

This feed additive in dry state was analyzed by an amino acid autoanalysis method to determine the contents of free amino acids. The amounts of main free amino acids were:

Free alanine: 0.95 wt %

Free glycine: 0.39 wt %

Free proline: 0.39 wt %

Free glutamic acid: 0.93 wt %

(total 2.66 wt %).

The metazoan animal-containing sludge recovered was dehydrated and dried to give a feed additive having a water content of 6 wt %. A mixed feed was prepared by mixing 90 parts by weight of a commercial fish-farming compound feed (Nippon Suisan Kaisha, Ltd., Nissui juvenile feed D-2, total concentration of main free amino acids: about 1.2 wt %) and 10 parts by weight of the feed additive.

Twenty juvenile sea breams (average weight 33.0 g) were fed on the mixed feed for 6 weeks, and the average weight was measured to be 56.5 g.

### Comparative Example 1

Twenty juvenile sea breams were fed for 6 weeks in the same manner as in EXAMPLE 1, except that the fish-farming compound feed alone was used as the feed. The average weight was measured to be 50.7 g. This result showed that the feed additive of EXAMPLE 1 containing large amounts of amino acids effectively increased preference.

### Comparative Example 2

Cultivation was performed in the same manner as in EXAMPLE 1, except that the quality of the raw water was changed to the following.

Raw water: beverage production wastewater containing 20 wt % protein, 10 wt % glucide and 5 wt % crude fat

The resultant sludge containing metazoan animals was dehydrated and dried in the same manner as in EXAMPLE 1 to give a feed additive having a water content of 6 wt %.

The amounts of main free amino acids in the metazoan animals in the obtained feed additive were measured by the same method, the results being described below:

Free alanine: 0.01 wt %

Free glycine: 0.04 wt %

Free proline: not detected

Free glutamic acid: 0.07 wt %

(total 0.12 wt %). The amounts of amino acids were significantly smaller than those in EXAMPLE 1 and even than those of the commercial feed used in COMPARATIVE EXAMPLE 1.

A mixed feed was prepared in the same manner as in EXAMPLE 1, except that this metazoan animal-containing sludge was used as the feed additive. Twenty juvenile sea breams were fed on the mixed feed for 6 weeks, and the average weight was measured to be 44.5 g.

Although the present invention has been described in detail with respect to some specific embodiments, the skilled person will appreciate that various modifications are possible within the spirit and the scope of the invention.

This application is based upon Japanese Patent Application No. 2012-271516 filed on Dec. 12, 2012, the entire contents of which are incorporated herein by reference.

### REFERENCE SIGNS LIST

1 FIRST AEROBIC REACTOR

2 SECOND AEROBIC REACTOR

3 SETTLING TANK

4 THICKENER

4a FIRST FILTER

4b SECOND FILTER

1. A feed additive comprising a metazoan animal or an aerobically biotreated sludge containing a metazoan animal, the content of the metazoan animal in the feed additive being 1 wt % or more on dry basis, the content of a free amino acid in the feed additive being 0.5 wt % or more on dry basis.

2. The feed additive according to claim 1, wherein the metazoan animal is based on rotifers.

3. The feed additive according to claim 1, wherein the content of the metazoan animal is 1 to 80 wt %.

4. The feed additive according to claim 1, wherein the content of a free amino acid in the feed additive is 0.5 to 5 wt % on dry basis.

5. The feed additive according to claim 1, wherein the free amino acid is at least one of arginine, lysine, leucine, isoleucine, valine, alanine, glycine, proline and glutamic acid.

6. A mixed feed comprising the feed additive described in claim 1 and a feedstuff, the content of the feed additive being 0.1 to 30 wt % on dry basis.

7. The mixed feed according to claim 6, wherein the content of the feed additive is 0.5 to 30 wt % on dry basis.

8. The mixed feed according to claim 6, wherein the feedstuff is at least one of fishmeals, cereals, soybeans, gluten meals, wheat flours, fodder yeasts, oils and fats.
